(19) United States
(12) Patent Application Publication
(10) Pub. No.: US 2007/0031639 A1
(43) Pub. Date: Feb. 8, 2007

(54) Articles having low wettability and methods for making

(75) Inventors: Ming Feng Hsu, Saratoga Springs, NY (US); Kripa Kiran Varanasi, Clifton Park, NY (US); Nitin Bhate, Rexford, NY (US); Gregory Allen O'Neil, Clifton Park, NY (US); Judith Stein, Schenectady, NY (US); Tao Deng, Clifton Park, NY (US); Shannon Maile Okuyama, Duanesburg, NY (US); Norman Arnold Turnquist, Sloansville, NY (US); Milivoj Konstantin Brun, Galway, NY (US); Farshad Ghasripoor, Scotia, NY (US); Kasiraman Krishnan, Clifton Park, NY (US); Christopher Fred Keimel, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/497,720

(22) Filed: Aug. 2, 2006

Related U.S. Application Data
(60) Provisional application No. 60/705,239, filed on Aug. 3, 2005.

(51) Int. Cl. G11B 5/64

(52) U.S. Cl. 428/141

(57) ABSTRACT

An article having low wettability is presented. The article comprises a body portion and a surface portion disposed on the body portion. The surface portion comprises a plurality of features disposed on the body portion, and the features have a size, shape, and orientation selected such that the surface portion has a wettability sufficient to generate, with a reference liquid, a contact angle of at least about 100 degrees. The features comprise a height dimension (h) and a width dimension (a), and are disposed in a spaced-apart relationship characterized by a spacing dimension (b). The ratio of b/a and the ratio of h/a are such that the drop exhibits metastable non-Wenzel behavior.

### CROSS REFERENCE TO RELATED APPLICATIONS

This Application claims priority to U.S. Provisional patent application Ser. No. 60/705,239, filed Aug. 3, 2005.

### BACKGROUND

This invention relates to surfaces having low liquid wettability. More particularly, this invention relates to surfaces incorporating a texture designed to provide low wettability. This invention also relates to articles comprising such surfaces, and methods for making such articles and surfaces.

The “liquid wettability”, or “wettability,” of a solid surface is determined by observing the nature of the interaction occurring between the surface and a drop of a given liquid disposed on the surface. A surface having a high wettability for the liquid tends to allow the drop to spread over a relatively wide area of the surface (thereby “wetting” the surface). In the extreme case, the liquid spreads into a film over the surface. On the other hand, where the surface has a low wettability for the liquid, the liquid tends to retain a well-formed, ball-shaped drop. In the extreme case, the liquid forms spherical drops on the surface that easily roll off of the surface at the slightest disturbance.

The extent to which a liquid is able to wet a solid surface plays a significant role in determining how the liquid and solid will interact with each other. A high degree of wetting results in relatively large areas of liquid-solid contact, and is desirable in applications where a considerable amount of interaction between the two surfaces is beneficial, such as, for example, adhesive and coating applications. By way of example, so-called “hydrophilic” materials have relatively high wettability in the presence of water, resulting in a high degree of “sheeting” of the water over the solid surface. Conversely, for applications requiring low solid-liquid interaction, the wettability is generally kept as low as possible in order to promote the formation of liquid drops having minimal contact area with the solid surface. “Hydrophobic” materials have relatively low water wettability; so-called “superhydrophobic” materials have even lower water wettability, resulting in surfaces that in some cases may seem to repel any water impinging on the surface due to the nature of the interaction between water drops and the solid surface.

Articles having tailored surface properties are used in a broad range of applications in areas such as transportation, chemical processing, health care, and textiles. Many of these applications involve the use of articles having a surface with a relatively low liquid wettability to reduce the interaction between the article surface and various liquids. In particular, the wetting properties of a material may be tailored to produce surfaces having properties that include low-drag or low-friction, self-cleaning capability, and resistance to icing, fouling, and fogging.

Metallic components are particularly susceptible to icing, fouling, etc., because metals generally have a high wettability for common liquids such as water. Much of the work devoted to making surfaces of metallic articles more resistant to wetting has depended on the use of hydrophobic, often polymeric, coatings. These coatings, though effective, are often limited in practical application by low wear resistance and temperature capabilities.

Therefore, there is a need to provide articles, such as metal articles, with durable surfaces having low liquid wettability. Moreover, there is a need for methods for making such surfaces and articles having such surfaces.

### BRIEF DESCRIPTION

Embodiments of the present invention meet these and other needs. For example, one embodiment is an article comprising a body portion and a surface portion disposed on the body portion. The surface portion comprises a plurality of features disposed on the body portion, and the features have a size, shape, and orientation selected such that the surface portion has a wettability sufficient to generate, with a reference liquid, a contact angle of at least about 100 degrees. The features comprise a height dimension (h) and a width dimension (a), and are disposed in a spaced-apart relationship characterized by a spacing dimension (b). The ratio of b/a and the ratio of h/a are such that the drop exhibits metastable non-Wenzel behavior.

### DETAILED DESCRIPTION

In the following description, like reference characters designate like or corresponding parts throughout the several views shown in the figures. It is also understood that terms such as “top,” “bottom,” “outward,” “inward,” and the like are words of convenience and are not to be construed as limiting terms. Furthermore, whenever a particular feature of the invention is said to comprise or consist of at least one of a number of elements of a group and combinations thereof, it is understood that the feature may comprise or consist of any of the elements of the group, either individually or in combination with any of the other elements of that group.

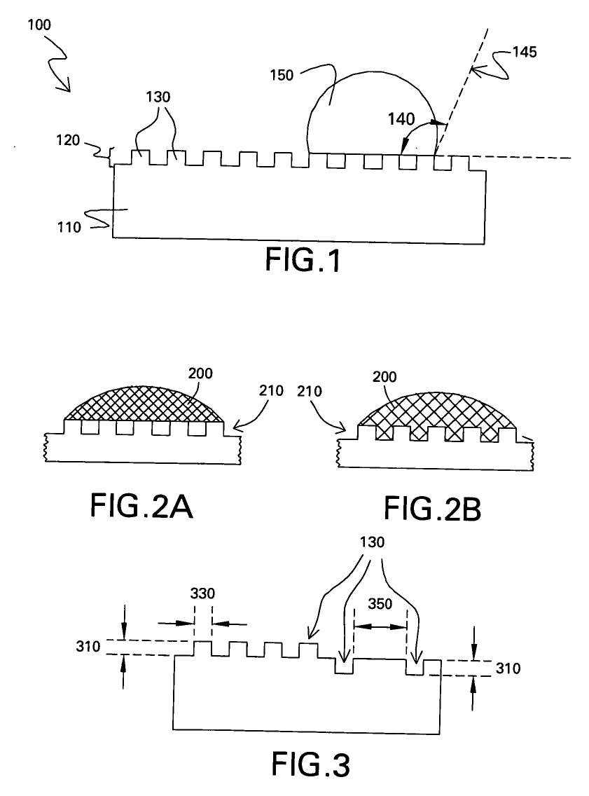

Referring to the drawings in general and to FIG. 1 in particular, it will be understood that the illustrations are for the purpose of describing a particular embodiment of the invention and are not intended to limit the invention thereto. FIG. 1 is a schematic cross-sectional view of a surface of an article of the present invention. Article 100 comprises a surface portion 120 disposed on a body portion 110. In certain embodiments, surface portion comprises a metal. As used herein, the term “metal” means a metallic material such as an elemental metal or an alloy. Suitable metals include, for example, metals comprising iron, nickel, cobalt, chromium, aluminum, copper, titanium, platinum, or any other suitable metallic element. In some embodiments, surface portion 120 consists essentially of a metal; that is, no coating is disposed over surface portion 120. In other embodiments, described in more detail below, a coating or other surface-energy modifying material is added to surface portion 120.

Surface portion 120 further comprises a plurality of features 130 disposed on the body portion 110. These features 130 have a size, shape, and orientation selected such that the surface portion 120 has a low liquid wettability. One commonly accepted measure of the liquid wettability of a surface 120 is the value of the static contact angle 140 formed between surface 120 and a tangent 145 to a surface of a droplet 150 of a reference liquid at the point of contact between surface 120 and droplet 150. High values of contact angle 140 indicate a low wettability for the reference liquid on surface 120. The reference liquid may be any liquid of interest. In many applications, the reference liquid is water. In other applications, the reference liquid is a liquid that contains at least one hydrocarbon, such as, for example, oil, petroleum, gasoline, an organic solvent, and the like. As described above, the term “superhydrophobic” is used to describe surfaces having very low wettability for water. As used herein, the term “superhydrophobic” will be understood to refer to a surface that generates a static contact angle with water of greater than about 120 degrees. Because wettability depends in part upon the surface tension of the reference liquid, a given surface may have a different wettability (and hence form a different contact angle) for different liquids. Surface portion 120, according to embodiments of the present invention, has a wettability sufficient to generate, with a reference liquid, a contact angle 140 of at least about 100 degrees, a contact angle that is considerably higher than that typically measured for flat metal surfaces.

As stated above, the size, shape, and orientation of features 130 are selected such that surface portion 120 of article 100 exhibits extraordinarily low wettability. The selection is based upon the physics underlying the interaction of liquids and rough solid surfaces. A drop of liquid resides on a textured surface typically in any one of a number of equilibrium states. In the “Cassie” state, depicted in FIG. 2a, a drop 200 sits on the peaks of the rough surface 210, trapping air pockets between the peaks. In the “Wenzel” state, depicted in FIG. 2b, drop 200 wets the entire surface 210, filling the spaces between the peaks with liquid. Other equilibrium states generally can be envisioned as intermediate states between pure Cassie and pure Wenzel behavior, where drops only partially fill the spaces between surface roughness features. As used herein, the term “non-Wenzel” refers to any state that does not exhibit pure Wenzel-state behavior; as such, the term “non-Wenzel” includes pure Cassie state behavior and any intermediate states that do not exhibit pure Wenzel behavior.

The particular state adopted by the drop on the surface depends on the overall energy of the drop/solid system, which in turn is a function of the geometric characteristics—such as the size, shape, and orientation—of the surface roughness features of the solid. For example, where the Cassie state results in a lower energy than the Wenzel state, an impinging drop will generally always exhibit Cassie state behavior. However, even in instances where the Wenzel state provides a lower energy, non-Wenzel state behavior still may be maintained due to the existence of an energy barrier between the two states, requiring the input of energy to achieve the transition from the “metastable” non-Wenzel state to the ultimately lower energy Wenzel state. An understanding of the relationship between surface geometry and energy enables surfaces to be designed to provide desired wettability characteristics, including contact angle and type of wetting state behavior exhibited by liquid on the solid surface.

In general, because a significant portion of a non-Wenzel-state drop is in contact with air pockets instead of the actual surface, a non-Wenzel state is more desirable for applications such as anti-icing surfaces, self-cleaning surfaces, and drag-resistant surfaces, where a lowered adhesion of drops to the solid surface is advantageous. In accordance with certain embodiments of the present invention, the surface portion 120 of an article 100 is designed such that, for a drop of a reference liquid disposed on surface portion 120, non-Wenzel-state drop behavior, such as Cassie state drop behavior, results in a lower energy state than Wenzel state drop behavior; that is, the non-Wenzel state is a stable state. Alternatively, surface portion 120 may be designed such that the non-Wenzel state drop behavior is a metastable condition, as described above. In such cases, the surface portion is designed such that a significant energy barrier must be overcome in making the transition from metastable non-Wenzel state behavior to Wenzel state behavior. Although designing for the metastable non-Wenzel state behavior results in a possibility that Wenzel state drops may form under certain conditions, such a design may have other advantages, as will be discussed in more detail, below. The size, shape, and orientation of features 130 have a strong effect not only on contact angle of a drop disposed on surface portion, but also on whether the behavior of the drop will be in a stable non-Wenzel state, a metastable non-Wenzel state, or a stable Wenzel state.

The size of features 130 (FIG. 1) can be characterized in a number of ways. In some embodiments, as shown in FIG. 3, at least a subset of the plurality of features 130 protrudes above the body portion 110 of the article. Moreover, in some embodiments at least a subset of the plurality of features is a plurality of cavities 300 disposed in the body portion 110. Features 130 comprise a height dimension (h) 310, which represents the height of protruding features above the body portion 110 or, in the case of cavities 300, the depth to which the cavities extend into the body portion 110. Features 130 further comprise a width dimension (a) 330. The precise nature of the width dimension will depend on the shape of the feature, but is defined to be the width of the feature at the point where the feature would naturally contact a drop of liquid placed on the surface of the article. The height and width parameters of features 130 have a significant effect on wetting behavior observed on surface portion 120.

Numerous varieties of feature shapes are suitable for use as features 130. In some embodiments, at least a subset of the features 130 has a shape selected from the group consisting of a cube, a rectangular prism, a cone, a cylinder, a pyramid, a trapezoidal prism, and a hemisphere or other spherical portion. These shapes are suitable whether the feature is a protrusion 320 or a cavity 300. As an example, in particular embodiments, at least a subset of the features comprises nanowires, which are structures that have a lateral size constrained to tens of nanometers or less and an unconstrained longitudinal size. Methods for making nanowires of various materials are well known in the art, and include, for example, chemical vapor deposition onto a substrate. Nanowires may be grown directly on surface portion 120 or may be grown on a separate substrate, removed from that substrate (for example, by use of ultrasonication), placed in a solvent, and transferred onto surface portion 120 by disposing the solvent onto the surface portion and allowing the solvent to dry.

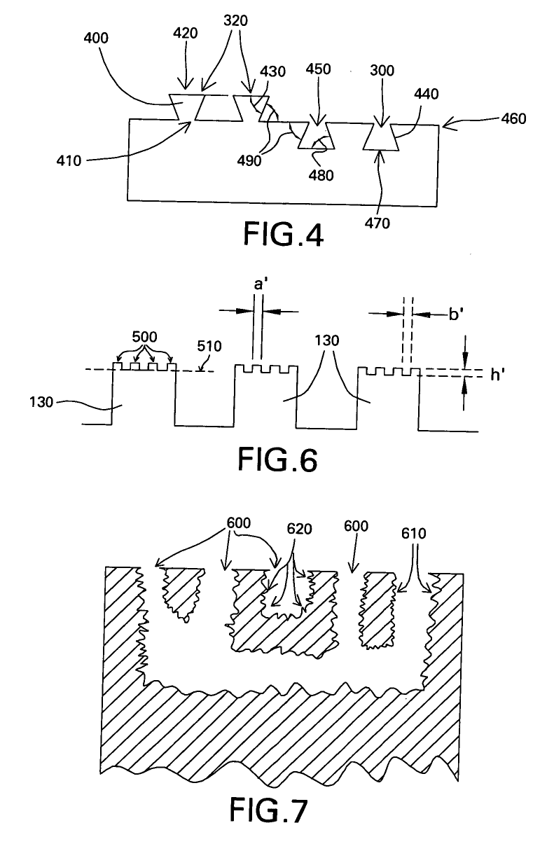

Referring now to FIG. 4, protruding features 320 are characterized by sidewalls 400 extending between a base 410, where the feature 320 is attached to the body portion 110, and a top 420. Top 420 and sidewall 400 intersect to form angle 430. In certain embodiments, angle 430 is up to about 90 degrees. Although angles greater than about 90 degrees are suitable in certain embodiments, under certain conditions such an arrangement may be less resistant to Wenzel state wetting than where angle 430 is about 90 degrees or less. Cavities 300 are also characterized by cavity sidewalls 440 that extend between cavity opening 450 disposed at the surface 460 of body portion 110 to cavity bottom 470. Bottom 470 and sidewalls 440 intersect to form cavity angle 480. In certain embodiments, cavity angle 480 is up to about 90 degrees, for the same reasons as described above for angle 430.

Feature orientation is a further design consideration in the engineering of surface wettability in accordance with embodiments of the present invention. One significant aspect of feature orientation is the spacing of features. Referring to FIG. 3, in some embodiments features 130 are disposed in a spaced-apart relationship characterized by a spacing dimension (b) 350. Spacing dimension 350 is defined as the distance between the edges of two nearest-neighbor features. Other aspects of orientation may also be considered, such as, for instance, the extent to which top 420 (or bottom 470 for a cavity) deviates from being parallel with surface 460, or the extent to which features 130 deviate from a perpendicular orientation with respect to the surface 460.

In some embodiments, all of the features 130 in the plurality have substantially the same respective values for h, a, and/or b (“an ordered array”), though this is not a general requirement. For example, the plurality of features 130 may be a collection of features, such as nanowires, for instance, exhibiting a random distribution of size, shape, and/or orientation. In certain embodiments, moreover, the plurality of features is characterized by a multi-modal distribution (e.g., a bimodal or trimodal distribution) in h, a, b, or any combination thereof. Such distributions may advantageously provide reduced wettability in environments where a range of drop sizes is encountered. Estimation of the effects of h, a, and b on wettability are thus best performed by taking into account the distributive nature of these parameters. Techniques, such as Monte Carlo simulation, for performing analyses using variables representing probability distributions are well known in the art. Such techniques may be applied in designing features 130 for use in articles of the present invention. Accordingly, it will be understood that where the parameters a, b, h, and the like are described herein in the context of the plurality of features, rather than individual features, those parameters are to be construed as representing median values for the plurality of features taken as a population.

Where drop size is assumed to be much greater than the size of features 130, an analysis of the physics of the interaction between a drop and surface portion 120 reveals that the ratios b/a and h/a have a significant effect on wetting behavior. See, for example, N. A. Patankar, Langmuir 2004, 20, 7097-7102. As stated above, in some instances surface portion 120 is designed such that non-Wenzel state behavior is the energetically stable state. In such embodiments, the ratios b/a and h/a are selected such that non-Wenzel state drop behavior, such as, for instance, Cassie-state behavior, results in a lower energy state than Wenzel state drop behavior for a drop of a reference liquid disposed on the surface portion, ensuring that drops will exhibit non-Wenzel state behavior. This is often achieved by forcing the relative spacing parameter (b/a) to very low values.

Although maintaining the drop state within the pure Cassie regime may be advantageous in some applications, other factors additional to drop state play a significant role in determining the practical wettability performance of an article. Many of the applications for low wettability surfaces, such as self-cleaning surfaces and anti-icing surfaces, for example, require not only a high contact angle but also a low level of friction and other contact forces between drop and surface to promote easy drop roll-off. At the low relative spacing (b/a) values required to maintain the Cassie regime, the high density of features 130 on surface portion 120 results in a high solid-liquid contact area. The high contact area may result in contact forces acting to keep the drop attached to the surface (“pinning forces”) sufficient to impede drop roll-off, even where contact angles are relatively high.

The present inventors have developed a design methodology for creating surface textures having high contact angle (low wettability) and easy drop roll-off. Through proper selection of b/a, and h/a, coupled with proper selection of materials based on the application environment, a surface can be designed such that drops of liquid impinging on the surface will exhibit non-Wenzel wetting combined with easy roll-off behavior. As b/a increases, the drop behavior changes from stable non-Wenzel state (assuming the drop originally was a non-Wenzel drop) to metastable non-Wenzel state, but the solid-liquid contact line length decreases due to the decreased feature density. The resultant decrease in pinning forces allows the drop to roll off the surface more easily than for surfaces with higher solid-liquid contact line length.

The ease of roll-off can be measured by determining the angle of tilt from the horizontal needed before a drop will roll off of a surface. A drop that requires a near vertical tilt is highly pinned to the surface, whereas a drop exhibiting easy roll-off will require very little tilt angle to roll off the surface. In some embodiments, the drop will roll off of the surface at the point where the force of gravity pulling on the drop equals the force pinning the drop to the surface. This situation can be represented by the following expression:
ρVg sin α=2πμβ (1);
where ρ is the liquid density, V is the volume of the drop, g is the gravity constant, α is the angle of inclination from the horizontal, μ is the pinning parameter, β is the fraction of the contact line that is pinned, and r is the radius of the contact area of the drop with the substrate. μ, the pinning parameter, is a material constant that is independent of the surface texture, but β and r are functions of the texture. The texture, in some embodiments, is represented by the parameters a, b, and h of the features 130. Where the drop is assumed to be spherical, equation (1) can be rewritten as

$$\begin{matrix}sin α = μ \cdot ( 2 π ) {( \frac{3}{π} )}^{\frac{1}{3}} \frac{1}{ρ g} \cdot {V}^{- \frac{2}{3}} \cdot β \cdot f ( θ ) ; \\ where & ( 2 ) \\ f ( θ ) = \frac{sin θ}{{( 2 - 3 cos θ + {cos}^{3} θ )}^{\frac{1}{3}}} , & ( 3 )\end{matrix}$$

with θ being the equilibrium contact angle and β being a function of the surface geometry. The expression for β can be simply derived from the geometry of the features being used. For example, for a Cassie-state drop in a simple situation in which the features are right rectangular prisms of width a and spacing b,

$$β = C ( \frac{a}{a + b} ) ; \qquad ( 4 )$$

where C is a constant that depends in large part on the shape of the area defined by contact of liquid with the solid surface.

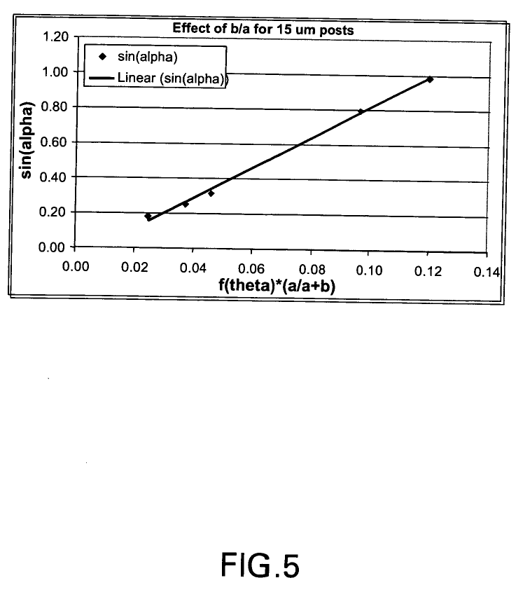

FIG. 5 shows the results of work aimed at validating the above analysis. Silicon substrates were provided via lithography with right rectangular prism features about 15 micrometers in width (a) and having various spacings (b) ranging from about 5 micrometers to about 150 micrometers. The substrates were then placed in a chamber with a vial of liquid fluorosilane, and the chamber was evacuated to allow the liquid to evaporate and condense from the gas phase onto the silicon substrate, thereby creating a hydrophobic film on the surface. The angle of tilt required to roll a drop of water off of the surface was recorded as a function of the feature spacing parameter. As shown in FIG. 5, the relationship between sin(α) and β·f(θ) was clearly linear, suggesting that the relationship set forth in Equation (3), above, does predict drop roll-off for textured surfaces of this type. Based on the analysis, the parameter R was estimated to be about 0.013 N/m for the material used in this work.

As is well known in the art, a drop of liquid on an inclined substrate often exhibits two different contact angles: an advancing contact angle on the lower side of the drop (the side that would be the leading edge were the drop to slide down the incline) and a receding contact angle on the higher side of the drop. The pinning parameter μ readily can be calculated based on its theorized relationship with advancing and receding contact angles. The pinning parameter is modeled as a force acting in the same direction as the surface tension force between the solid and the vapor (σₛᵥ) at the advancing (lower) edge of the drop, and as a force acting in the opposite direction as σₛᵥ at the receding (higher) edge of the drop. Applying the force balance commonly known in the art to describe forces acting on a drop as it sits on a solid substrate in the presence of a vapor environment:
For the advancing front on the inclined substrate,

$$cos {θ}_{A} = \frac{{σ}_{SV} - μ - {σ}_{SL}}{{σ}_{LV}} .$$

For the receding front on the inclined substrate,

$$cos {θ}_{R} = \frac{{σ}_{SV} + μ - {σ}_{SL}}{{σ}_{LV}} .$$

Adding the two equations,

$$cos {θ}_{A} - cos {θ}_{R} = \frac{2 μ}{{σ}_{LV}} ;$$

where θ_{A} and θ_{R} are the advancing and receding contact angles, respectively, and σ_{LV} is the surface tension force between the vapor and the liquid. For water and air, this quantity is known to be about 0.073N/m. Thus, for the equation immediately above, the pinning parameter can be readily calculated using the following procedure: 1) Prepare a smooth surface of the substrate material of interest; 2) Measure OA and OR (advancing and receding angles respectively); 3) Calculate R using the equation above.

Once μ is known, equations (2) and (3) above can be used to predict the roll-off angle of a surface having features of a known geometry. The lower bound for the relative spacing b/a can be set where a maximum roll-off angle (that is, maximum allowable resistance to roll-off) is achieved. The relative spacing b/a can increase from there, which will create surfaces having even less resistance to roll-off, but the relative spacing will be bound on the upper end at the point where the drop stops exhibiting metastable non-Wenzel behavior; that is, the point where the spacing is too great and the liquid begins filling the gaps between the features. This point is reached where the pressure in the drop due to internal (LaPlace) pressure plus any dynamic pressure due to, for instance, an impact velocity, is sufficient to overcome the energy barrier between non-Wenzel and Wenzel states afforded by the surface geometry, which ultimately defines the surface tension forces supporting the drop in the non-Wenzel state.

The ability to maintain non-Wenzel state behavior in the metastable regime depends upon the energy barrier that exists between non-Wenzel and Wenzel states, and this energy barrier is determined in large part by the selection of b/a and h/a. In certain embodiments, b/a is in the range from about 0.3 to about 10, and h/a is in the range from about 0.5 to about 10. In particular embodiments these ranges are used for post-type features where a is in the range from about 1 to about 100 micrometers and where the substrate material has an inherent contact angle (i.e., contact angle measure for smooth surface) of greater than about 90 degrees. By generating an energy barrier of sufficient magnitude, transition to the Wenzel state can be significantly impeded even for drops with high energy, such as the kinetic energy due to high impingement velocities. In some embodiments, b/a is further selected to maintain a low pinning force with a drop of reference liquid. As described above, the pinning force is often measured by measuring the angle of surface tilt from horizontal required to cause roll-off of the drop from the substrate. In particular embodiments a low pinning force is defined where roll-off angle is up to about 45 degrees.

In applications where at least a portion of the liquid is disposed on article 100 via condensation rather than impingement, at least some of the drops may likely exhibit Wenzel state behavior, especially where features 130 are larger than the size of the drops condensing onto article 100. In such cases roll-off may be more difficult to achieve than for pure Cassie drops, but, as described above, the surface may still be designed to provide sufficiently low frictional interaction between drop and features 130 to allow acceptable roll off. Applications involving condensation include, for instance, condenser equipment and steam turbine components, and such applications are described in more detail later herein.

The values selected for a, b, and h will depend on the application, and, at least for applications involving drop impingement rather than condensation, the selection usually will be such that these parameters are significantly smaller than an expected drop size. In some embodiments a, b, and h are all within the range from about 1 nm to about 500 micrometers. In particular embodiments, a is in the range from about 10 nm to about 100 microns. The ratio b/a, in some embodiments, is up to about 20, and in particular embodiments b/a is up to about 10. However, considerations of maintaining metastable non-Wenzel drop behavior lead to embodiments where the selection of the b/a parameter will depend on the specific range for a, in order to maintain an effective activation energy barrier between the metastable non-Wenzel state and the stable (lower energy) Wenzel state. More specifically, in some embodiments, b/a is selected to provide a capillary pressure of greater than about 100 Pascals (Pa) acting on a drop in contact with the surface. A 100 Pa pressure minimum may provide sufficient resistance to overcome Laplace pressure and gravitational forces acting to promote a transformation of drop state from metastable non-Wenzel to the Wenzel state. Accordingly, in some embodiments a is in the range from about 10 nm to about 50 nm, b/a is up to about 350, and h/a is up to about 100. In some embodiments a is in the range from about 50 nm to about 500 nm, b/a is up to about 100, and h/a is up to about 100. In some embodiments a is in the range from about 500 nm to about 5 micrometers, b/a is up to about 35, and h/a is up to about 100. In some embodiments a is in the range from about 5 micrometers to about 50 micrometers, b/a is up to about 10, and h/a is up to about 100. Finally, in some embodiments a is in the range from about 50 micrometers to about 100 micrometers, b/a is up to about 3.5, and h/a is up to about 100. The ratio h/a is limited on the upper end by manufacturing capability and by the need for robust features that can withstand stress and impact in certain applications. In certain embodiments h/a is at least 0.5.

In many applications, features of multiple size scales are desirable, in part because impacting drops of liquid may break apart into smaller drops, or a range of drop sizes may be inherently present in the environment, thus requiring features of smaller size scales to be present to maintain the effects described above. Moreover, the presence of multiple size-scale features amplifies the low-wettability effects obtained on surfaces textured as described above, allowing for a broader acceptable range of feature size, shape, and orientation. As shown in FIG. 6, in some embodiments at least one feature 130 comprises a plurality of secondary features 500 disposed on the feature 130. In particular embodiments, secondary features 500 are disposed on each feature 130. Although the example depicted in FIG. 6 shows an ordered array of identical secondary features 500, such an arrangement is not a general requirement; random arrangements and other distributions in size, shape, and orientation may be appropriate for specific applications. Secondary features 500 may be disposed on any surface of features 130, including sidewalls, and they may be disposed on the surface portion itself within spaces between features 130 as well. Secondary features 500 may be characterized by a height dimension h′ referenced to a feature baseline plane 510 (whether the secondary feature protrudes above plane 510 or is a cavity disposed in feature 130 to a depth h′ below plane 510), a width dimension a′, and a spacing dimension b′, all parameters defined analogously to a, b, and h described above. The parameters a′, b′, and h′ will often be selected based on the conditions particular to the desired application. In some embodiments a′, b′, and h′ are all within the range from about 1 nm to about 1000 nm

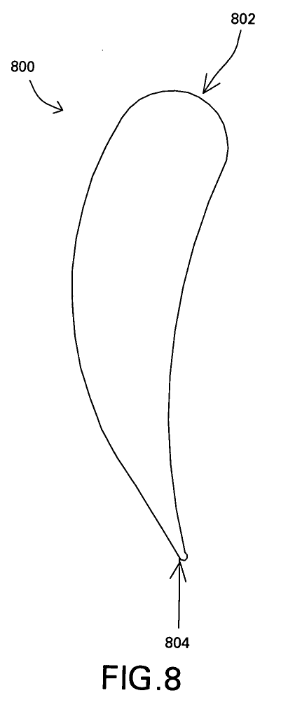

Another example of multiple size scale features is depicted in FIG. 7. In this example, pores 600 are cavity features disposed on body portion 110. The pores may be interconnected pores (“open porosity”) or isolated cavities (“closed porosity”). The size, shape, and spacing of the pores 600, are selected based on the requirements of the desired application. In some embodiments, the pores have a width (pore diameter) up to about 500 micrometers, and in other embodiments the pores have a pore density of at least about 60 pores per linear inch (ppi). Examples of porous surfaces that may be suitable in certain embodiments include open cell metal foams commercially available from Porvair Fuel Cell Technology and open cell, gradient metal foams commercially available from Mitsubishi Materials Corporation. Pores 600 are bounded by pore walls 610, which comprise a metal. In this exemplary embodiment, pore walls comprise pore wall features 620 disposed at pore walls 610. Pore wall features 620 may be structures protruding above pore walls 610 or depressions disposed in the walls. In certain embodiments, the pore wall features have a characteristic dimension, such as, for example, the aforementioned height h′, width a′, or spacing b′, of less than 1 micrometer.

The surface portion 120 (FIG. 1) comprises a metal. In some embodiments of the present invention, features 130 comprise a material selected from the group consisting of a metal, an intermetallic compound, and a semi metal. In other embodiments, features 130 comprise a non-metal, such as, for example, a ceramic or a polymer. Although many of these materials have moderate to high inherent wettability (that is, wettability as measured for a nominally flat surface) for many important liquids, such as water and oil, altering article surfaces in accordance with embodiments of the present invention may significantly reduce the wettability of articles made from such materials. Examples of suitable metals from which surface portion 120 and features 130 can be made include, but are not limited to, aluminum, copper, iron, nickel, cobalt, gold, platinum, titanium, zinc, tin, and alloys comprising at least one of these elements, such as steel, high-temperature superalloys, and aluminum alloys. Examples of suitable intermetallic compounds include, but are not limited to, compounds containing at least one of the elements listed above, such as aluminides and other intermetallics. Silicon is one non-limiting example of a suitable semi-metal. In some embodiments, surface portion 120 comprises the same metal as the features 130. In particular embodiments, body portion 110, surface portion 120, and features 130 are integral and comprise the same metal composition.

Features 130 can be fabricated and provided to article 100 by a number of methods. In some embodiments, features 130 are fabricated directly on surface portion 120 of article 100. In other embodiments, features 130 are fabricated separately from body portion 110 and then disposed onto body portion 110 at surface portion 120. Disposition of features 130 onto body portion 110 can be done by individually attaching features 130, or the features may be disposed on a sheet, foil or other suitable medium that is then attached to the body portion 110. Attachment in either case may be accomplished through any appropriate method, such as, but not limited to, welding, brazing, mechanically attaching, or adhesively attaching via epoxy or other adhesive.

The disposition of features 130 may be accomplished by disposing material onto the surface of the article, by removing material from the surface, or a combination of both depositing and removing. Many methods are known in the art for adding or removing material from a surface. For example, simple roughening of the surface by mechanical operations such as grinding, grit blasting, or shot peening may be suitable if appropriate media/tooling and surface materials are selected. Such operations will generally result in a distribution of randomly oriented features on the surface, while the size-scale of the features will depend significantly on the size of the media and/or tooling used for the material removal operation. Lithographic methods are commonly used to create surface features on etchable surfaces, including metal surfaces. Ordered arrays of features can be provided by these methods; the lower limit of feature size available through these techniques is limited by the resolution of the particular lithographic process being applied.

Electroplating methods are also commonly used to add features to surfaces. An electrically conductive surface may be masked in a patterned array to expose areas upon which features are to be disposed, and the features may be built up on these exposed regions by plating. This method allows the creation of features having higher aspect ratios than those commonly achieved by etching techniques. In particular embodiments, the masking is accomplished by the use of an anodized aluminum oxide (AAO) template having a well-controlled pore size. Material is electroplated onto the substrate through the pores, and the AAO template is then selectively removed; this process is commonly applied in the art to make high aspect ratio features such as nanorods. Nanorods of metal and metal oxides may be deposited using commonly known processing, and these materials may be further processed (by carburization, for example) to form various ceramic materials such as carbides. As will be described in more detail below, coatings or other surface modification techniques may be applied to the features to provide even better wettability properties.

Micromachining techniques, such as laser micromachining (commonly used for silicon and stainless steels, for example) and etching techniques (for example, those commonly used for silicon) are suitable methods as well. Such techniques may be used to form cavities (as in laser drilling) as well as protruding features. Where the plurality of features 320 includes cavities 300, in some embodiments surface portion 120 comprises a porous material, such as, for example, an anodized metal oxide. Anodized aluminum oxide is a particular example of a porous material that may be suitable for use in some embodiments. Anodized aluminum oxide typically comprises columnar pores, and pore parameters such as diameter and aspect ratio may be closely controlled by the anodization process, using process controls that are well known to the art to convert a layer of metal into a layer of porous metal oxide.

In short, any of a number of deposition processes or material removal processes commonly known in the art may be used to provide features to a surface. As described above, the features may be applied directly onto body portion 110 of article 100, or applied to a substrate that is then attached to body portion 110.

In certain applications, service conditions are conducive to the use of polymeric coatings, fluorinated materials, and other traditional low-wettability materials. Thus, in certain embodiments of the present invention, these materials may be applied to surface portion 120 to provide enhanced resistance to wetting. However, many applications, including, for instance, certain medical devices, heat exchangers, aircraft components, and turbomachinery such as aircraft engines, which would benefit from the use of articles having low wettability in accordance with embodiments of the present invention, are subject to harsh chemical, thermal, and/or tribological conditions that preclude the use of traditional polymer-based low-wettability materials and coatings. Thus, in some embodiments, the surface portion 120 and its features 130 are free of any polymeric materials or coatings; that is, they consist essentially of metallic, intermetallic, or ceramic materials. These materials generally have inherently high to moderate wettability, however, and thus the effect of surface texturing by providing features 130 as described herein may not always suffice to provide desired levels of wettability, absent some means of lowering the inherent wettability of the features 130.

In some embodiments, article 100 further comprises a surface modification layer (not shown) disposed on surface portion 120. This layer is formed, in one embodiment, by overlaying a layer of material at surface portion 120, resulting in a coating disposed over features 130. Hydrophobic hardcoatings are one suitable option. As used herein, “hydrophobic hardcoatings” refers to a class of coatings that have hardness in excess of that observed for metals, and exhibit wettability resistance sufficient to generate, with a drop of water, a static contact angle of at least about 70 degrees. Diamond-like carbon (DLC) coatings, which typically have high wear resistance, have been applied to metallic articles to improve resistance to wetting (see, for example, U.S. Pat. No. 6,623,241); As a non-limiting example, fluorinated DLC coatings have shown significant resistance to wetting by water. Other hardcoatings such as nitrides, carbides, and oxides, may also serve this purpose. Particularly suitable materials candidates that have been demonstrated by the present inventors to produce contact angles of about 90 degrees and higher with water when deposited on smooth metal substrates include tantalum oxide, titanium carbide, titanium nitride, chromium nitride, boron nitride, chromium carbide, molybdenum carbide, titanium carbonitride, and zirconium nitride. These hardcoatings, and methods for applying them, such as chemical vapor deposition (CVD), physical vapor deposition (PVD), etc., are known in the art, and may be of particular use in harsh environments. Fluorinated materials, such as fluorosilanes, are also suitable coating materials that exhibit low wettability for certain liquids, including water. Finally, if conditions allow, the coating may comprise a polymeric material. Examples of polymeric materials known to have advantageous resistance to wetting by certain liquids include silicones, fluoropolymers, urethanes, acrylates, epoxies, polysilazanes, aliphatic hydrocarbons, polyimides, polycarbonates, polyether imides, polystyrenes, polyolefins, polypropylenes, polyethylenes or mixtures thereof.

Alternatively, the surface modification layer may be formed by diffusing or implanting molecular, atomic, or ionic species into the surface portion 120 to form a layer of material having altered surface properties compared to material underneath the surface modification layer. In one embodiment, the surface modification layer comprises ion-implanted material, for example, ion-implanted metal. Ion implantation of metallic materials with ions of boron (B), nitrogen (N), fluorine (F), carbon (C), oxygen (O), helium (He), argon (Ar), or hydrogen (H) may lower the surface energy (and hence the wettability) of the implanted material. See, for example, A. Leipertz et al., “Dropwise Condensation Heat Transfer on Ion Implanted Metallic Surfaces,” http://www.ltt.uni-erlangen.de/inhalt/pdfs/tk_gren.pdf; and Xuehu Ma et. al, “Advances in Dropwise Condensation Heat Transfer: Chinese Research”, Chemical Engineering Journal, 2000, volume 78, 87-93.

In one embodiment, a diffusion hardening processes such as a nitriding process or a carburizing process is used to dispose the surface modification layer, and thus the surface modification material comprises a nitrided material or a carburized material. Nitriding and carburizing processes are known in the art to harden the surface of metals by diffusing nitrogen or carbon into the surface of the metal and allowing strong nitride-forming or carbide-forming elements contained within the metal to react to form a layer of reacted material or a dispersion of hard carbide or nitride particles, depending on the metal composition and processing parameters. For steels, nitriding processes usually take place in a temperature range of about 500° C.-550° C. Nitriding processes known in the art include ion nitriding, gas nitriding, and salt-bath nitriding, so named based upon the state of the nitrogen source used in the process. In one example, the contact angle (measured using water as reference liquid) of 403 steel having a surface finish of 32 microinches was increased from about 60 degrees to about 115 degrees by ion nitriding. A preliminary observation of the surface of the nitrided surface applied to mirror-finish specimens suggests that the nitriding process may deposit nano-scale features at the surface in addition to reducing the inherent surface energy of the metal.

The surface modification layer may be applied after features 130 have been provided on surface portion 120. Alternatively, features 130 may be formed after applying surface modification layer to surface portion 120. The choice of order will depend on the particular processing methods being employed and the materials being used for features 130, surface portion 120, and/or body portion 110.

As described above, the selection of specific surface parameters depends in part upon the application for which article 100 is to be used. Below are included non-limiting examples of specific applications in accordance with embodiments of the present invention.

Ice accumulation: Icing takes place when a water droplet (sometimes supercooled) impinges upon the surface of an article, such as an aircraft component or a component of a turbine (for example, a gas or wind turbine), and freezes on the surface. The build-up of ice on aircraft, turbine components, and other machinery exposed to the weather reduces performance, increases safety risks, and incurs costs for periodic ice removal operations. Certain embodiments of the present invention are believed to reduce the formation, adhesion, and/or accumulation of ice on such surfaces. In certain embodiments, article 100 is an aircraft component, such as, for example, a wing, tail, or fuselage of an aircraft. In other embodiments, article 100 is a gas turbine component, such as a component of a gas turbine engine used to power an aircraft. In still further embodiments, article 100 is a component of a wind turbine assembly.

Non-limiting examples of aircraft engine components that are suitable as articles in embodiments of the present invention include the nacelle inlet lip, splitter leading edge, booster inlet guide vanes, fan outlet guide vanes, sensors and/or their shields, and fan blades. Certain components, such as fan blades, while sometimes made of metal, are often made of carbon-based composite materials. In such cases surface portion 120 may comprise a thin foil, such as a metal foil, attached to the composite body portion 110, where features 130 are disposed on the foil. In other cases, features 130 may be disposed directly onto the composite article via a coating method as described above, or the composite article itself may be machined or otherwise formed to have integral features at its surface.

Icing is a significant problem for wind turbines, as the build-up of ice on various components such as anemometers and turbine blades reduces the efficiency and increases the safety risks of wind turbine operations. Wind turbine blades and other components are often made of lightweight composite materials such as fiberglass in order to save weight, and the build-up of ice can deleteriously load the blades to a point that significantly reduces their effectiveness. In certain embodiments of the present invention, article 100 is a component, such as a turbine blade, anemometer, gearbox, or other component, of a wind turbine assembly. Features 130 may be disposed on such components in a manner similar to that described above for composite fan blades in jet engines.

Under conditions associated with aircraft anti-icing applications, water drop sizes typically range from about 10 micrometers to about 70 micrometers. To deal with these conditions, one exemplary article of the present invention is an article provided with features for which h/a has a value up to about 10, b/a has a value of up to about 4, and a has a value of up to about 3 micrometers. In this specific case, stable Cassie state behavior is expected for h/a in the range from about 2-10 and b/a up to about 2, while metastable behavior is expected for h/a in the range from about 1 to about 3 and b/a of about 4. It should be noted, however, that the exemplary embodiments described above are not intended to limit the invention; different parameters will likely be appropriate where drop size, environmental variables, and materials of construction vary.

Droplet roll-off (shedding): As described above, the surface feature size, shape, and orientation play a major role in determining the wetting characteristics of drops on the surface. Designs requiring easy drop roll-off may be developed using the analysis described above for balancing the need for non-Wenzel state wetting with the need for low drop pinning forces. In one example, silicon substrates coated with a fluorosilane film were etched using lithographic techniques to provide right rectangular prism features having width (a) of about 15 micrometers and height (h) of about 25 micrometers. A variety of surface designs using these features at different spacing parameters (b=about 5 to about 150 micrometers) was tested using water drops as the reference liquid. Based on an analysis of the capillary forces due to surface energy and the pressure forces acting on the drop, it was predicted that a spacing of about 90 micrometers was the upper limit before Wenzel wetting would occur, with a metastable non-Wenzel regime calculated to be in the about 30 micrometer to about 90 micrometer range. The results validated the predictions. At or below a spacing of about 30 micrometers, the roll-off angle was high, above about 60 degrees. However, spacings of 60 micrometers and 75 micrometers yielded roll-off angles of about 20 degrees. Drops disposed on surfaces having spacings of about 110 micrometers and about 150 micrometers tended to remain pinned to the surface even when the surface was tilted to a 90 degree angle.

Steam turbine moisture control: In certain applications, such as, for example, steam turbines, metal components are subject to impinging drops of water as well as condensing drops. As steam expands in a turbine, water droplets (typically fog-sized) appear in the flow stream. These droplets agglomerate on the turbine blades and other components and shed off as larger drops that can cause thermodynamic, aerodynamic, and erosion losses in turbines. By making the turbine component surfaces less wettable, such as superhydrophobic, droplets can shed from these surfaces before they can agglomerate into bigger drops, and this mechanism may thus prevent moisture losses in steam turbines. In accordance with embodiments of the present invention, the surface designed for use in these applications represents a trade-off by balancing the desire for Cassie-like drop behavior and high resistance to wetting by impacting drops (which factors urge a high density of features 130) on the one hand, with the desire for facile shedding of small drops (which urges a surface with a lower density of features 130).

As a practical matter, these design considerations are applied to arrive at a surface design that promotes a high contact angle and easy drop roll-off. In many static applications, drop roll-off occurs where gravitational forces acting on the drop overcome the frictional forces pinning the drop to the surface. The Bond Number, a parameter commonly used in the field of fluid mechanics, can be applied in estimating the desired space between features 130 to allow drop roll-off at a desired drop size. Where article 100 is a turbine blade or other turbine component subject to aerodynamic forces, drop roll-off occurs when drag forces overcome the frictional forces pinning the drop to the surface. In these cases the Weber number, a parameter commonly used in the fields of aerodynamics and fluid mechanics, can be applied to estimate the desired space between features 130 to allow drop roll-off at a desired drop size. The Weber number allows an estimation of the maximum drop size that can be obtained under the given environmental and flow conditions. By taking this size into account, a surface can be designed that minimizes the number of features contacting the drop, and hence the forces pinning the drop to the surface. If the drops are spaced apart sufficiently, the drops may be shed by aerodynamic forces before they are able to coalesce into larger, more damaging drops.

Turbine components: In certain embodiments, article 100 is a turbine component, and in particular embodiments, the turbine is a wind turbine, a steam turbine, or a gas turbine. A suitable example of such a component, as has been stated above, is a component comprising an airfoil; rotating blades and stationary components (vanes or nozzles) are examples. As shown in FIG. 8, an airfoil 800 (shown in cross-section) typically comprises a leading edge 802 and a trailing edge 804 relative to the expected directional flow of fluid. In some embodiments, features (not shown) are disposed over the entire surface of airfoil 800. However, in certain cases features may be necessary or desired only at a particular portion or portions of airfoil 800, such as leading edge 802 and/or trailing edge 804. The nature of the application will determine the extent to which features are to be disposed on an article.

While various embodiments are described herein, it will be appreciated from the specification that various combinations of elements, variations, equivalents, or improvements therein may be made by those skilled in the art, and are still within the scope of the invention.

What is claimed is:

1. An article comprising:
a body portion; and
a surface portion disposed on the body portion;
wherein the surface portion comprises a plurality of features disposed on the body portion, and the features have a size, shape, and orientation selected such that the surface portion has a wettability sufficient to generate, with a reference liquid, a contact angle of at least about 100 degrees;
wherein the features comprise a height dimension (h) and a width dimension (a), and wherein the features are disposed in a spaced-apart relationship characterized by a spacing dimension (b), and the ratio of b/a and the ratio of h/a are such that the drop exhibits metastable non-Wenzel behavior.

2. The article of claim 1, wherein the ratio of b/a is suitable to maintain a sufficiently low pinning force with a drop of reference liquid to allow a roll-off angle of up to about 45 degrees.

3. The article of claim 1, wherein the ratio of b/a is up to about 20.

4. The article of claim 1, wherein the ratio of h/a is at least about 0.5.

5. The article of claim 1, wherein the ratio of b/a is in the range from about 0.3 to about 10.

6. The article of claim 5, wherein the ratio of h/a is in the range from about 0.5 to about 10.

7. The article of claim 1, wherein a is in the range from about 1 nm to about 500 micrometers; h is in the range from about 1 nm to about 500 micrometers; and b is in the range from about 1 nm to about 500 micrometers.

8. The article of claim 7, wherein a is in the range from about 1 micrometer to about 100 micrometers.

9. The article of claim 1, wherein a is in the range from about 10 nm to about 50 nm, b/a is up to about 350, and h/a is up to about 100.

10. The article of claim 1, wherein a is in the range from about 50 nm to about 500 nm, b/a is up to about 100, and h/a is up to about 100.

11. The article of claim 1, wherein a is in the range from about 500 nm to about 5 micrometers, b/a is up to about 35, and h/a is up to about 100.

12. The article of claim 1, wherein a is in the range from about 5 micrometers to about 50 micrometers, b/a is up to about 10, and h/a is up to about 100.

13. The article of claim 1, wherein a is in the range from about 50 micrometers to about 100 micrometers, b/a is up to about 3.5, and h/a is up to about 100.

14. The article of claim 1, wherein at least one feature further comprises a plurality of secondary features disposed on the feature.

15. The article of claim 14, wherein each feature comprises a plurality of secondary features disposed on the feature.

16. The article of claim 15, wherein the secondary features comprise a height dimension (h′) and a width dimension (a′), and wherein the secondary features are disposed in a spaced-apart relationship characterized by a spacing dimension (b′); and wherein a′ is in the range from about 1 nm to about 1000 nm; h′ is in the range from about 1 nm to about 1000 nm; and b′ is in the range from about 1 nm to about 1000 nm.

17. The article of claim 1, wherein the plurality of features is characterized by a multi-modal distribution in at least one dimension selected from the group consisting of height (h), width (a), and spacing (b).

18. The article of claim 1, wherein at least a subset of the plurality of features protrude above the body portion of the article.

19. The article of claim 18, wherein at least a subset of the protruding features has a shape selected from the group consisting of a cube, a rectangular prism, a cone, a cylinder, a pyramid, a trapezoidal prism, and a hemisphere or other spherical portion.

20. The article of claim 1, wherein the features comprise at least one material selected from the group consisting of a ceramic, a metal, an intermetallic compound, and a semi-metal.

21. The article of claim 1, wherein the surface portion comprises a metal.

22. The article of claim 21, wherein the features comprise the same metal as the surface portion.

23. The article of claim 22, wherein the body portion, the surface portion, and the features comprise the same metal.

24. The article of claim 1, wherein at least a subset of the plurality of features is a plurality of cavities disposed in the body portion.

25. The article of claim 24, wherein the cavities comprise pores bounded by pore walls.

26. The article of claim 25, wherein the pore walls comprise an anodized metal oxide.

27. The article of claim 26, wherein the anodized metal oxide comprises aluminum oxide.

28. The article of claim 25, wherein the pore walls comprise wall features disposed at the pore walls, the wall features comprising at least one selected from the group consisting of structures protruding above the walls and depressions disposed in the walls.

29. The article of claim 28, wherein the wall features have a characteristic dimension of less than about 1 micrometer.

30. The article of claim 25, wherein the pore walls comprise a metal.

31. The article of claim 1, wherein the article further comprises a surface energy modification layer disposed on the surface portion.

32. The article of claim 31, wherein the surface energy modification layer comprises ion-implanted metal.

33. The article of claim 32, wherein the ion-implanted metal comprises implanted ions of at least one element selected from the group consisting of B, N, F, O, C, He, Ar, and H.

34. The article of claim 31, wherein the surface energy modification layer comprises a nitrided material or a carburized material.

35. The article of claim 31, wherein the surface energy modification layer comprises a coating disposed over the features.

36. The article of claim 30, wherein the coating comprises at least one material selected from the group consisting of a hydrophobic hard coat, a fluorinated material, and a polymer.

37. The article of claim 36, wherein the hydrophobic hardcoat comprises a material selected from the group consisting of diamond-like carbon (DLC), fluorinated DLC, tantalum oxide, titanium carbide, titanium nitride, chromium nitride, boron nitride, chromium carbide, molybdenum carbide, titanium carbonitride, and zirconium nitride.

38. The article of claim 1, wherein the article comprises a component of a turbine assembly.

39. The article of claim 38, wherein the turbine assembly is selected from the group consisting of a wind turbine, a gas turbine, and a steam turbine.

40. The article of claim 39, wherein the gas turbine is disposed in an aircraft engine.

41. The article of claim 40, wherein the component is at least one component selected from the group consisting of a nacelle lip, a splitter leading edge, a booster inlet guide vane, a fan outlet guide vane, a fan blade, a sensor, and a sensor shield.

42. The article of claim 38, wherein the component comprises an airfoil.

43. The article of claim 1, wherein the article is disposed on an aircraft.

44. The article of claim 43, wherein the article comprises an aircraft wing, an aircraft tail, or aircraft fuselage.

45. The article of claim 1, wherein the article comprises a wind turbine assembly component selected from the group consisting of a turbine blade, an anemometer, and a gearbox.
